(19) United States
(12) Patent Application Publication
(10) Pub. No.: US 2007/0181054 A1
(43) Pub. Date: Aug. 9, 2007

(54) Heated volatile dispensing device with use-up indicator

(76) Inventors: Joel E. Adair, Racine, WI (US); Brian T. Davis, Burlington, WI (US); Gopal P. Ananth, Racine, WI (US); Padma Prabodh Varanasi, Racine, WI (US)

Correspondence Address: S.C. JOHNSON & SON, INC., 1525 HOWE STREET, RACINE, WI, 53403-2236, US

(21) Appl. No.: 11/347,614

(22) Filed: Feb. 3, 2006

(51) Int. Cl. G01N 21/00

(52) U.S. Cl. 116/207; 422/125; 422/56

(57) ABSTRACT

Heated volatile dispensers are disclosed that are provided with automated use-up indicators. The indicators are associated with a porous substrate. A migrateable dye is covered by meltable material adjacent the substrate. Heating of a substrate such as a slab impregnated with an insect repellent both causes the insect repellent to dispense and melts the covering. The dye then migrates to a visible surface of the substrate to indicate a degree of use. The extent of migration, and the patterns formed on the visible surface by the migrating dye, indicate the extent to which the volatile air treatment chemical has been dispensed.

### CROSS-REFERENCE TO RELATED APPLICATIONS

Not applicable.

### STATEMENT REGARDING FEDERALLY SPONSORED RESEARCH/DEVELOPMENT

Not applicable.

### BACKGROUND OF THE INVENTION

The present invention relates to indicators that provide information to consumers about the extent of use of consumable air-treatment products. More specifically it relates to air treatment dispensing devices where a heater causes dispensing of an air treatment chemical and also initiates a use-up cue system that is in the form of a migrating indicator dye.

A variety of prior art devices are known that use heat to dispense air treatment chemicals. For example, it is known that a porous pad, wick, or other substrate can be impregnated or coated with a volatizable air treatment chemical. When heat is applied to the substrate, the air treatment chemical is dispensed into the air.

In some of these devices a portion of the substrate is dipped into an associated reservoir of the air treatment chemical (typically a mix of solvent and volatile treatment chemical). The porous substrate then acts as a wick that draws the chemical to the heated region, as needed.

The level of the air treatment chemical/solvent mix in the reservoir is typically visible to consumers. Thus, the emptying of the reservoir provides a way for consumers to monitor when more air treatment chemical is needed. However, for some applications it is preferred not to have to use the somewhat bulky storage reservoir. Further, that type of reservoir system may have certain other disadvantages besides size (e.g. cost).

Hence, the art has developed a variety of porous materials that are impregnated at a factory with air treatment chemicals. They are then positioned adjacent or on a heater, and the heating dispenses the air treatment chemical into the air from the slab (by itself and/or with assistance of a fan or the like). However, the heating of such a substrate does not typically significantly change the appearance of the substrate, particularly when the substrate is a solid rather than a gel.

Thus, producers of such products will often estimate average useful life of such products under normal usage conditions, and note that information on their packaging. However, these substrates may be used with a variety of different types of heaters which heat at different temperatures or in different ways. Even where only a single type of heater is to be used with a particular type of substrate, heater performance may be inconsistent over time from model to model.

Thus, while estimated averaging of useful life can provide rough guidance regarding useful life, that estimate will not be exact in most cases. As a result, some companies prefer to provide expected life information in a manner that encourages the product to be thrown away somewhat earlier than the average statistical life. This reduces the risk that there will be significant use of the product after the product has become ineffective, albeit at the cost of a somewhat higher level of waste due to disposing of some product which still has some useful life.

Even where information is provided by the manufacturer regarding expected useful life, some consumers will not learn of, or alternatively not apply, that information. Rather, they will assume what an appropriate useful life is or should be, and thus in some cases prematurely throw away the product, and in others use it after its effective life is over. Further, even where the consumer is initially aware of the appropriate assumption for a usage life, they may forget about the need to replace the product until well after the product has become ineffective.

There are a number of automatic use-up cue systems which have been developed and applied in varied contexts which rely on some form of chemical reaction to cause an automatic color change after use for a specified period. However, systems of this type are difficult to reliably apply in a heated environment, particularly where the exact heat conditions that the product will be exposed to is not controllable or predictable. This is particularly important because chemical reactions typically proceed at very different speeds depending on the environmental temperature.

Some other known indicator devices rely on the migration of a dye to a visible position as an indicator of the extent of use or use-up. See e.g. U.S. Pat. Nos. 4,212,153, 4,903,254 and 6,701,864. However, these devices typically require consumer intervention to initiate the dye migration, and sometimes require complex structures to control use of the dye. They thereby unnecessarily increase the cost of the indicator and may also reduce the likelihood of consumer acceptance, particularly where the manner of using the product is not conceptually straightforward. See also U.S. Pat. No. 4,987,849.

Thus, there is still a need in the art to have improved use-up cue systems for heated volatile dispensers which do not rely on viewing liquid levels in a reservoir and can adjust for varied heating conditions.

### BRIEF SUMMARY OF THE INVENTION

In one aspect the invention provides a substrate capable of dispensing a volatile air treatment chemical upon heating of the substrate. The substrate includes a use indicator associated with the substrate and configured to automatically communicate an extent to which the air treatment chemical has been dispensed from the substrate as the substrate is heated. The indicator includes at least one dye, and a covering configured to restrict migration of the dye prior to heating of the covering, and to permit migration of the dye to a visible surface in response to heating of the covering.

Upon heating of the substrate, the dye can at least in part migrate to the visible surface. The extent to which the dye becomes visible at the visible surface is indicative of the extent to which the air treatment chemical has been dispensed from the substrate.

In preferred forms the visible surface is on a peripheral top surface of the substrate, the covering is made of a material that can be melted by heating such as a wax or polymer, and the substrate has at least two viewing positions along visible surfaces of the substrate. The migrating dye can reach a first of the viewing positions before reaching a second of the viewing positions, and the migrating dye being visibly present at the first of said viewing positions but not at the second of said viewing positions will be indicative of a lesser degree of use-up of the air treatment chemical than if the migrating dye is visible at both of said first and second viewing positions.

In other forms the substrate can have an array of pre-formed “quick migration” pathways extending from the covering to adjacent the visible surface for causing preferential migration of the dye through the pathways once migration of the dye begins. These can be uniformly or non-uniformly spaced across the substrate.

In some aspects a peripheral surface of the substrate is pre-marked with symbolic or textual indications such that they indicate a degree of use-up of the air treatment chemical once the dye reaches adjacent that pre-marked indication. For example, the markings ¼, ½, ¾, and “replace” can appear along a visible surface of the substrate. As the die progressively reaches each, information regarding the extent of use is communicated.

In another form a peripheral surface of the substrate is pre-marked with a symbolic or textual indication (e.g. “New”), and the subsequent hiding of that indication by migrating dye indicates a degree of use-up of the air treatment chemical.

While the dye can be stored prior to use in a separate cavity, it can also be pre-positioned in expandable channels of the substrate prior to heating the substrate. For example, substrates made of polyethylene terephthalate (“PET”) or comparable polymers are known to have their pore size expand in response to heating. By using a migrateable dye with it, such a system can be achieved. Examples of suitable dyes are Cartasol dyes, sold by the Clariant Corporation.

In another form the substrate is a stepped construction of substrate material. After heating the covering the migrating dye is able to migrate to reach an exposed surface of a first step of the substrate stack before it reaches an exposed surface of another step of the substrate stack. This facilitates a patterned depiction of dye in a specified order, thereby providing additional informational.

In the most preferred forms the substrate is a porous solid material that has been impregnated with the air treatment chemical such as insect control actives, fragrances, sanitizers and deodorizers. The invention is particularly well suited to dispense insect control repellents and insecticides, and provide information to the public as to when sufficient dispensing has occurred to provide initial protection, and when sufficient dispensing has occurred to render the substrate ineffectual thereafter.

One possible embodiment provides a single viewing position along a top surface of the substrate where as more dye appears, more use of the air treatment chemical is indicated. For example, the darker the color at that viewing position, the more use that has occurred. There could even be a color chart pre-printed and attached adjacent the viewing position to provide a quick comparison of colors to correlated usage levels.

Alternatively, the substrate could have multiple viewing positions along visible surfaces of the substrate or device. The substrate will be configured via thickness, preferential flow passages, or other means such that the dye reaches some of the viewing positions before others. There can be pre-marking on the substrate indicating to a consumer that the dye reaching a certain position first means initiation or partial use-up, and the dye reaching another position indicates more complete or complete use-up.

The markings on the surfaces can be textual or symbolic. The use-up message can be communicated with reference to them, or with reference to particular symbols. For example, the dye could be configured to fill a quarter of a circle or a quarter of a rectangle first, followed by completing a half or more. Alternatively, the visible surface of the substrate could have various bars that are sequentially filled in or covered or connected.

Further, the device could be provided with an visible circle that is pre-marked on the top surface. Its central portion is colored first. The expansion of the coloration to an outer surrounding circle could then indicate further use.

In another form the invention provides a device for dispensing an air treatment chemical into a surrounding air environment in response to heating of a substrate. The device has a porous substrate to which has been applied the air treatment chemical, a dye positioned in, against, or adjacent the substrate, and means for controlling migration of the dye such that migration of the dye prior to the heating is restricted, and migration of the dye to a visible surface after such heating is facilitated. The degree to which the dye becomes visible along the visible surface constitutes an indication of the extent to which the air treatment chemical has been dispensed from the substrate.

In the most preferred form the means for controlling the initiation is a meltable covering or encasement, such as a meltable coating made of a wax or a wax/polymer mix. It is preferable that the wax won't melt at lower than about 50° C., preferably not lower than 60° C. Microcrystaline parafin waxes are suitable for this purpose. An example of an especially preferred wax/polymer mix is microcrystalline paraffin and high density polyethylene.

In alternative embodiments, the means for controlling the initiation can be a peel-off or intervening layer that is physically removed by the consumer immediately prior to heating. In yet another alternative, the means for controlling the initiation could be that the porous material is of a nature that its pore size increases upon heating. The dye could be selected to have a size that would not fit through the pores (and thus be trapped) until the pore sizes increase sufficiently under heating conditions.

In yet another form the invention provides a method of producing an air treatment device having an automatic use-up indicator. One covers a migrateable dye with a meltable substance, and positions the covered dye proximate to a porous substrate to which has been applied an air treatment chemical.

A wide variety of volatile air treatment chemicals can be dispensed via heated volatile dispensers, as is well known in the art. This may include, for example, insect control actives, fragrances, sanitizers and deodorizers. Particularly preferred insect control actives are insect control repellents and insecticides such as pyrethroids such as transfluthrin or metofluthrin, mixed, if used in a liquid form, with from 99 to 95 wt percent of a suitable, volatile solvent. Hydrocarbon solvents such as Exxon Corporation's Isopar solvents are examples. Alternatively, even solid or gel form air treatment chemicals could be used provided that upon heating they will volatilize.

A preferred substrate is a porous heat stable slab-like substrate, such as one of the porous substrates conventionally used for dispensing insect repellents. Examples include, without limitation, sintered ceramics, compressed cellulosic materials, porous polymers, and silica or other particles bound into a mass by a resin material.

The migrating dye may be of varied types. It is preferred that the dye be heat stable. However, even where this is not the case, the instability of the dye can provide an additional piece of information. For example, the initial migration might provide one form of information, and a further color change of the dye after it first appears (due to further heating) could communicate additional usage. In any event, one preferred migrating dye is guaiazulene dye.

It should be appreciated that the principles of the present invention can be applied to a wide variety of devices. For example, the exact nature of the heater is not critical. While electrical heaters are preferred, even flame heaters (e.g. insect control lanterns) can have the principles of the present invention effectively applied to them. In any event, one form of electrical heater that may be used with insect repellent slabs is the insect mat heater sold by S. C. Johnson & Son, Inc. under the Raid® brand.

The present invention thus provides an automatic means of indicating to a consumer the extent to which consumable portions of air treatment devices have been used up. The substrates of the present invention are inexpensive to produce, reliable, and conceptually straightforward insofar as a consumer's ability to readily understand how they operate. They help avoid waste due to the premature disposal of such consumables even when they still have considerable useful life, and they help reduce consumer dissatisfaction which can be caused by use of a consumable after its effective life is over.

The foregoing and other advantages of the present invention will be apparent from the following description. In that description reference is made to the accompanying drawings which form a part thereof, and in which there is shown by way of illustration, and not limitation, preferred embodiments of the invention. Such embodiments do not necessarily represent the full scope of the invention, and reference should therefore be made to the claims herein for interpreting the scope of the invention.

### BRIEF DESCRIPTION OF THE DRAWINGS

FIG. 1 is a schematic cross-sectional view of an air-treatment device in accordance with the present invention;

FIG. 2 depicts a set of cross-sectional, and corresponding plan, views of the substrate of FIG. 1, at various stages after heating, showing progressive filling of a semi-circle by a migrateable dye;

FIG. 3 depicts another set of cross-sectional, and corresponding plan, views of an alternative substrate which could be used with the FIG. 1 heater, at various stages after heating, showing how pre-formed expandable passageways can be used to direct a migrateable dye first to a bar design and then to fill in a semi-circle, where the migrateable dye (prior to heating) is trapped in those passageways;

FIG. 4 depicts yet another set of cross-sectional, and corresponding plan, views of an alternative substrate which could be used with the FIG. 1 heater, at various stages after heating, showing how another array of pre-formed expandable passageways can be used to direct a migrateable dye first to a portion of a semi-circle, and then to fill the rest of the semi-circle, where the migrateable dye (prior to heating) is trapped in those passageways;

FIG. 5 depicts a set of top plan views indicating how in another alternative substrate (through use of clustered preferred pathways or other means) shading could start at the center of a circle and then fill out the rest of the circle;

FIG. 6 depicts another set of top plan views indicating how in another alternative substrate (through use of clustered preferred pathways or other means) the coloration could completely fill a central circle, and then fill a surrounding larger circular area;

FIG. 7 depicts a set of top plan views indicating how another substrate could have its entire top surface gradually change color upon heating, with the degree of color change indicating the degree of use of the air treatment chemical; and

FIG. 8 is a view similar to FIG. 7, but of a slightly different embodiment where a top surface of the substrate had marked thereon a word that becomes hidden as the substrate becomes more and more dyed on its top surface.

### DETAILED DESCRIPTION OF THE PREFERRED EMBODIMENTS

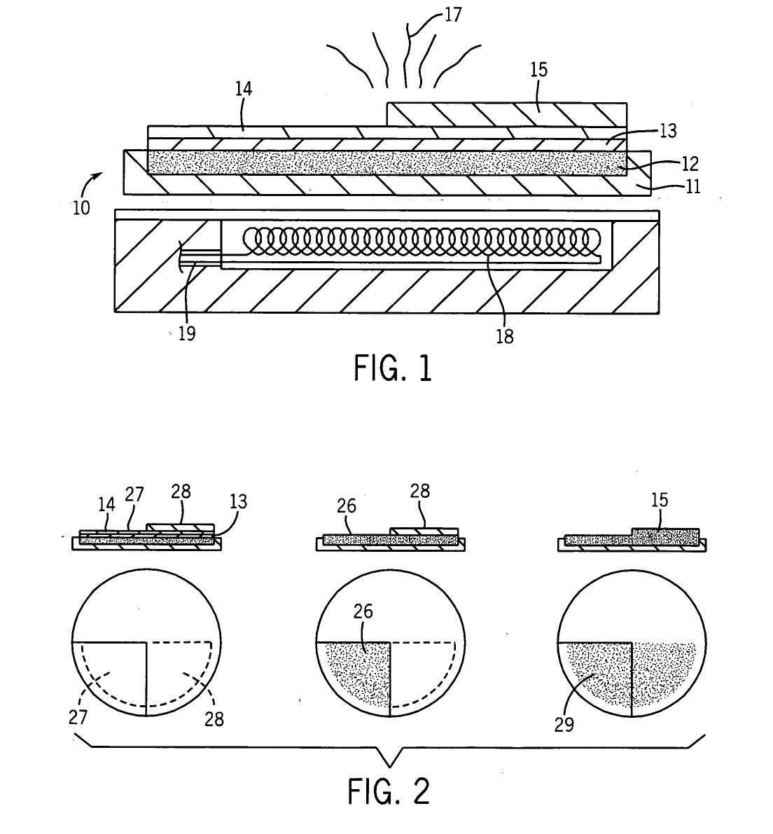

Referring first to FIGS. 1 and 2, there is shown an air treatment device 10 which has a substrate with a base 11, a cavity filled with a migrateable dye 12, a wax layer covering 13, a first, thin, porous substrate layer 14, and a second, somewhat thicker, porous substrate layer 15. The base 11 is cup-shaped, heat resistant, and impermeable to the dye.

The dye cavity is semi-circular and aligned with the semi-circular viewing position 29 at the top of the substrate layers 14/15. The substrate layer 14 is circular in top view. The layer covering 13 is semi-circular in top view, and can also extend down along an inner diameter side of the dye 12. The top substrate layer 15 constitutes three-quarters of a circle.

The porous substrate layers 14/15 are preferably pre-impregnated with an insect control repellent 17 which is dispensed to the air as the substrate is heated. An electrical heater 18 heats the substrate and is powered by a conventional electrical connection 19.

When the heater 18 is turned on, one of the effects is to melt the layer covering 13. This frees the dye 12 so that it begins to migrate upwardly into substrate layer 14. Because of the thinness of substrate layer 14, very shortly after heating begins a first one-quarter 26 will become visibly dyed (see the middle drawing of FIG. 2). However, it will take substantially longer for the dye to also migrate through a quarter circle corresponding to where substrate layer 15 overlies the dye 12.

Thus, the indicator will not appear as in the right drawing of FIG. 2 until much later. Through appropriate selection of the dye, the solvents, the pore structure, possibly thickeners mixed with the dye or air treatment chemical, the substrate thickness, and the heaters, the semi-circle can be caused to fill the remaining one-half quite slowly, and preferably only at about the time the air treatment chemical is used up.

If desired, the dye can be mixed with additional, or can provide the only, air treatment chemical. However, in most cases we prefer to have the air treatment chemical separately impregnate the substrate outside of the dye cavity.

FIG. 2 confirms that the substrate layers 14 and 15 form a stepped structure. Hence, the dye reaches the top exposed surface of the first step 27 long before it reaches the top exposed surface of the second step 28.

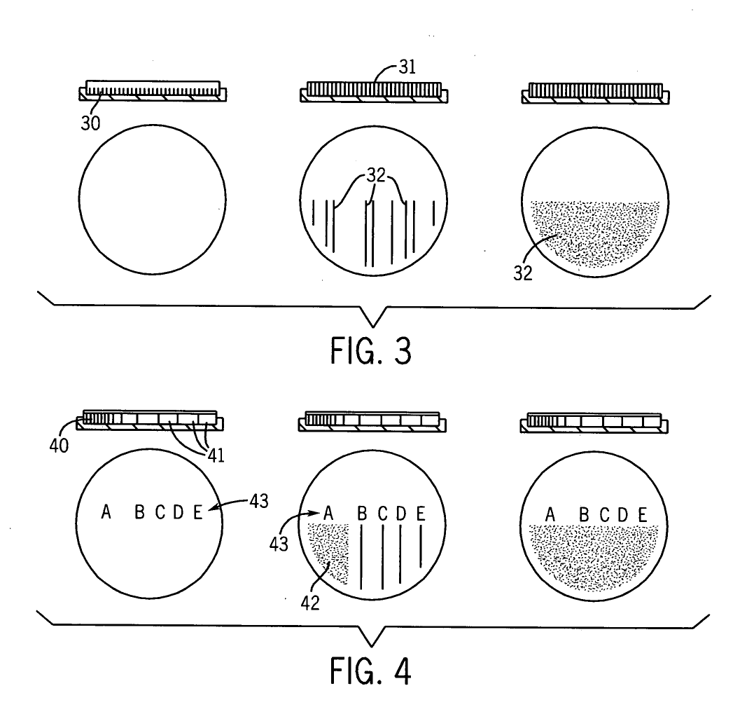

FIGS. 3 and 4 depict structures where the dye is stored within aligned passageways 30 prior to heating. These passageways may be narrowed at their upper end so that they do not permit upward migration to visible surface 31 until heating occurs. Then, after heating, those pores expand enough for the dye to migrate first through some of the larger passageways corresponding in FIG. 3 to particular bars, and corresponding in FIG. 4 to bars and a region. Further heating causes further expansion of pores, and thus completion of the semi-circle 32. While a variety of substrates may have this expansion capability, one possible material to achieve this is polyethylene terephthalate.

FIG. 4 shows how some of the passageways with larger diameters can be grouped at a side 40, while others 41 can be spaced at other positions. Note that this results in a segment 42 being filled first. Note also the lined designations A, B, C, D and E are permanent markings that provide information regarding the degree of use.

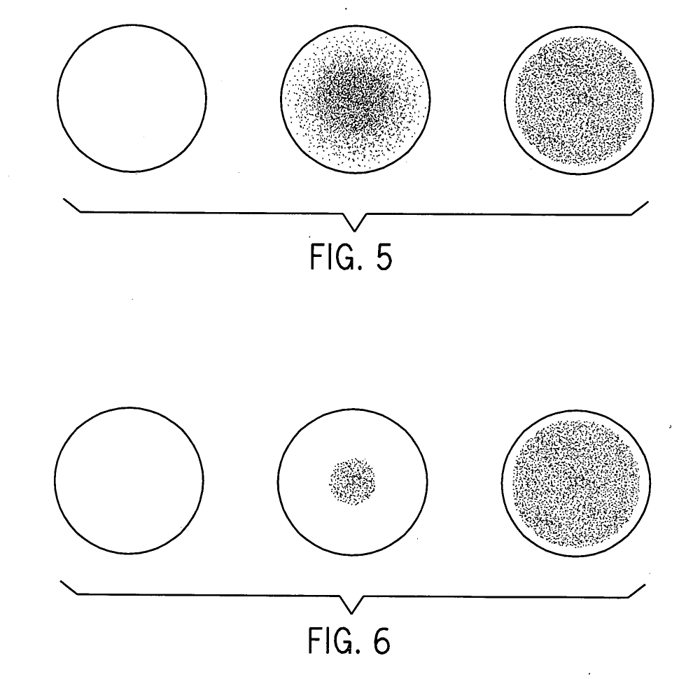

As shown in FIGS. 5 and 6, by utilizing a high concentration of easy flow passages near the center of a substrate it is possible to cause the centers to shade or darken first, thereby providing another indication of extent of use.

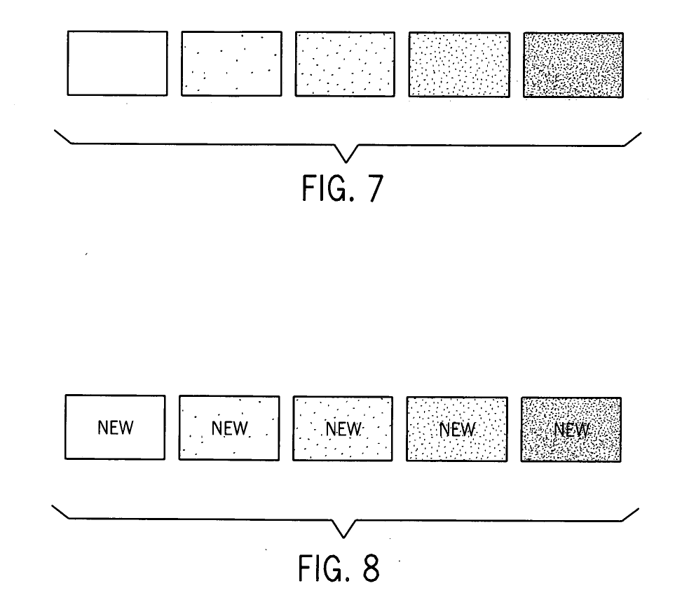

For the alternative designs of FIGS. 7 and 8, a bottom rectangular dye cavity permits uniform upward migration of the dye after heating, resulting in the top surface of the substrate becoming progressively more colored as use continues. A color chart of a permanent nature might be placed adjacent the substrate to compare the color hue at any given time with a specified degree of use-up.

The FIG. 8 embodiment could be very similar to the FIG. 7 embodiment except that there is a permanent marking of the word “NEW” on the top surface of the substrate. It progressively becomes more hidden as the dye migrates to that surface. For this purpose, the dye could have a color identical to the color of the text.

As should be appreciated from the examples provided above, the present invention can be applied in a wide variety of ways. For example, the substrates could be square, spherical, or have many other shapes. Thus, the claims should not be construed as being limited to just the disclosed preferred embodiments.

### INDUSTRIAL APPLICABILITY

The present invention provides automated migrating dye use-up cues for use with devices that dispense volatile materials in response to heating.

What is claimed is:

1. A substrate capable of dispensing a volatile air treatment chemical upon heating of the substrate, the substrate comprising:
a use indicator associated with the substrate and configured to automatically communicate an extent to which the air treatment chemical has been dispensed from the substrate as the substrate is heated, the use indicator comprising:
at least one dye; and
a covering configured to restrict migration of the dye prior to heating of the covering, and to permit migration of the dye to a visible surface in response to heating of the covering;
wherein upon heating of the substrate, the dye can at least in part migrate to the visible surface; and
wherein the extent to which the dye becomes visible at the visible surface is indicative of the extent to which the air treatment chemical has been dispensed from the substrate.

2. The substrate of claim 1, wherein the visible surface is on a peripheral surface of the substrate.

3. The substrate of claim 1, wherein the covering comprises a meltable material that can be melted by heating.

4. The substrate of claim 3, wherein the covering comprises a wax.

5. The substrate of claim 4, wherein the covering further comprises a polymer.

6. The substrate of claim 1, wherein:
the substrate has at least two viewing positions along visible surfaces of the substrate;
the dye can reach a first of said viewing positions before reaching a second of said viewing positions; and
the dye being visibly present at the first of said viewing positions but not at the second of said viewing positions will be indicative of a lesser degree of use-up of the air treatment chemical than if the dye is visible at both of said first and second viewing positions.

7. The substrate of claim 1, wherein the substrate has an array of pre-formed pathways extending from adjacent the covering to adjacent the visible surface for causing preferential migration of the dye through the pre-formed pathways once migration of the dye begins.

8. The substrate of claim 7, where the pre-formed pathways are not uniformly spaced across the substrate.

9. The substrate of claim 1, wherein a peripheral surface of the substrate is pre-marked with a symbolic or textual indication which indicates a degree of use-up of the air treatment chemical once the dye reaches adjacent that pre-marked indication.

10. The substrate of claim 1, wherein a peripheral surface of the substrate is pre-marked with a symbolic or textual indication, and the indication is such that it can be hidden by migrating dye to indicate a degree of use-up of the air treatment chemical.

11. The substrate of claim 1, wherein the dye is pre-positioned in expandable channels of the substrate prior to heating the substrate.

12. The substrate of claim 1, wherein the substrate has a stepped construction, and after heating the covering the dye can reach an exposed surface of a first step of the substrate stack before it reaches an exposed surface of a second step of the substrate stack.

13. The substrate of claim 1, wherein the substrate is a porous solid material that has been impregnated with the air treatment chemical.

14. The substrate of claim 1, wherein the air treatment chemical is selected from the group consisting of insect control actives, fragrances, sanitizers and deodorizers.

15. The substrate of claim 14, wherein the insect control actives are selected from the group consisting of insect control repellents and insecticides.

16. A device for dispensing an air treatment chemical into a surrounding air environment in response to heating of a substrate, the device comprising:
a porous substrate to which has been applied the air treatment chemical;
a dye positioned in, against, or adjacent the substrate; and
means for controlling migration of the dye such that migration of the dye prior to said heating is restricted, and migration of the dye to a visible surface after such heating is facilitated.

17. The device of claim 16, wherein a degree to which the dye becomes visible along said visible surface constitutes an indication of an extent to which the air treatment chemical has been dispensed from the substrate.

18. A method of producing an air treatment device having an automatic use-up indicator, the method comprising:
covering a migrateable dye with a meltable substance; and
positioning the dye with the covering proximate to a porous substrate to which has been applied an air treatment chemical.
